(19) United States
(12) Patent Application Publication
(10) Pub. No.: US 2015/0213734 A1
(43) Pub. Date: Jul. 30, 2015

(54) MEDICAL IDENTIFICATION DEVICE LINKED TO ELECTRONIC MEDICAL PROFILE AND METHOD FOR FABRICATING SAME

(71) Applicant: My ID Square, LLC, Merion Station, PA (US)

(72) Inventor: Irene Berger Glickman, Merion Station, PA (US)

(21) Appl. No.: 14/611,165

(22) Filed: Jan. 30, 2015

Related U.S. Application Data
(60) Provisional application No. 61/933,483, filed on Jan. 30, 2014.

(51) Int. Cl. G09F 3/00; G06K 19/06

(52) U.S. Cl. CPC G09F 3/005; G06K 19/06037

(57) ABSTRACT

In one embodiment, a wearable medical identification device that is linked to an online emergency medical profile of the wearer. The device includes a translucent substrate, and a first layer deposed on the translucent substrate, where the first layer includes an inverse image of a digital identifier corresponding to a uniform resource locator (URL). A second layer having a generally uniform color is deposed on the first layer. A third layer is deposed on the second layer and has one or more alphanumeric indicia including the URL in plain text characters. The device may include a bracelet, necklace, or other wearable portion.

### CROSS-REFERENCE TO RELATED APPLICATION

This application claims priority to co-pending U.S. Provisional Patent Application Ser. No. 61/933,483, filed Jan. 30, 2014, the disclosure of which is incorporated herein by reference in its entirety.

### BACKGROUND

The disclosure relates, generally, to alerting one person about another person's medical condition, and more particularly, to medical identification devices.

Conventionally, medical identification devices (medical IDs or IDs) refer to tags, bracelets, and other jewelry that inform third parties of one or more medical conditions of a wearer by means of information printed, stamped, or otherwise displayed on the device. Medical IDs are important because over 95% of emergency personnel look for medical IDs in emergencies. Half of all medical errors occur because of mistakes made upon admission or discharge from the hospital, and wearing a medical ID protects against potentially harmful medical errors. Medical IDs record and communicate critical medical history in the event that the wearer is unable to do so. Medical IDs can prevent emergencies by facilitating the securing of accommodations or getting help before a situation turns into something that requires emergency care.

Conventional medical IDs limit the amount of medical information that can be conveyed due teo space limitations, i.e., there is limited surface area on which to print or stamp words, symbols, or other visual indicia of one or more medical conditions, and wording must be in a typeface sufficiently large for a third party to be able to quickly and easily discover and read under emergent circumstances, often when the wearer is unconscious or in severe distress.

### SUMMARY

Embodiments of the present invention provide medical IDs, e.g., in the form of aluminum identification tags or translucent plastic bracelet squares, that are linked to an online emergency medical profile of the wearer, as well as methods for the fabrication of such medical IDs.

In one embodiment, the present invention provides a medical identification device including a translucent substrate, and a first layer deposed on the translucent substrate. The first layer includes an inverse image of a digital identifier.

In another embodiment, the present invention provides a medical identification device including a translucent substrate having an inverse image of a digital identifier deposed thereon. The digital identifier corresponds to a uniform resource locator and is capable of being imaged, in its non-inverse form, by an imaging device, through the translucent substrate.

In a further embodiment, the present invention provides a method for fabricating a portion of a medical identification device. The method includes the steps of: generating a digital identifier corresponding to a uniform resource locator; deposing an inverse image of the digital identifier on a translucent substrate; and deposing, on top of the digital identifier, a layer having a generally uniform color.

### BRIEF DESCRIPTION OF THE DRAWINGS

FIG. 1 shows an exemplary medical ID device consistent with a first embodiment of the invention;

FIG. 2 shows the reverse side of the tag portion of the medical ID device of FIG. 1;

FIG. 3 shows an exemplary medical ID device consistent with a second embodiment of the invention;

FIG. 4 shows an exemplary medical ID device consistent with a third embodiment of the invention;

FIG. 5 shows an exemplary medical ID bracelet consistent with a fourth embodiment of the invention;

FIGS. 6(a)-6(d) collectively show an exemplary emergency medical profile, in one embodiment of the invention;

FIG. 7 shows an exemplary method for fabricating a tag portion of a medical ID device, in one embodiment of the invention; and

FIG. 8 shows the superposition of layers of a tag portion of a medical ID device, in one embodiment of the invention.

### DETAILED DESCRIPTION

Embodiments of the invention provide various medical ID devices, including bracelets and necklaces, that include a scannable “quick-response” (QR) code (or other digital identifier including scannable indicia), which is linked to a personal, customizable online emergency profile of the wearer, which permits the code to be scanned, e.g., by medical personnel, for the purpose of obtaining the wearer's medical information.

A medical ID consistent with one embodiment of the invention has a URL on one side of the ID along with a unique tag code, and on the other side of the ID is a QR code corresponding to a unique URL. An emergency responder simply scans the QR code (or browses to the URL on the back of the ID and enters the tag code) with the camera (or other imaging device) of a smart phone, tablet, or computer, to view the wearer's emergency medical profile and have the wearer's emergency contacts be alerted automatically via text and email that the wearer's ID has been scanned.

Even in a non-emergency, this configuration permits the wearer to maintain up-to-date medical records to share with a doctor, hospital, or school nurse whenever needed, by simply wearing and scanning his or her ID. Anyone with an Internet connection can update his or her own medical information and control what information is included in the emergency medical profile, which is maintained separately from health care providers' own records.

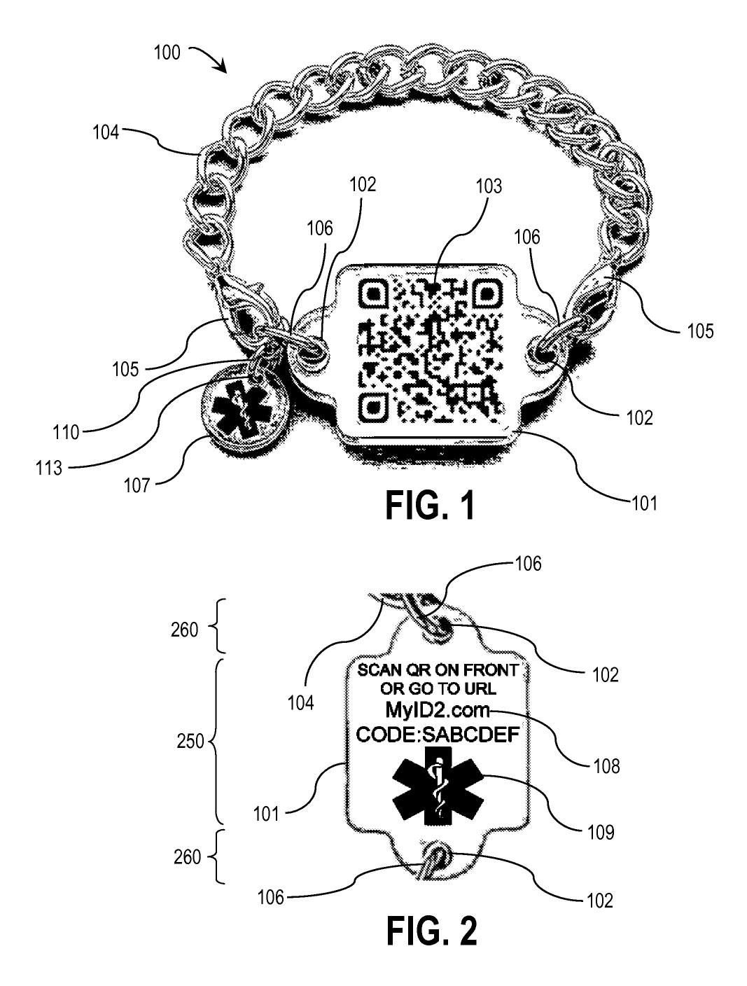

Turning first to FIG. 1, an exemplary medical ID device 100 consistent with a first embodiment of the invention is illustrated. As shown, in this embodiment, device 100 is a medical ID bracelet that includes a tag portion 101 detachably fastened to a bracelet portion 104 via a pair of through holes 102 formed in tag portion 101. In this embodiment, bracelet portion 104 is formed from a chain of individual links and has a lobster-claw clasp 105 at each end. Each lobster-claw clasp releasably fastens to a respective connector link 106 that is coupled to a respective through hole 102 at one end of tag portion 101. One of connector links 106 is also coupled to a medallion tag 107 by means of a connector link 110 coupled to through hole 113 formed in medallion tag 107. Medallion tag 107 displays a recognized medical alert-related symbol, such as a caduceus, a blue star of life (a six-pointed star), a red cross symbol, or the like, on one or both sides, to indicate the presence of a medical condition and/or the availability of medical information for the wearer.

The front side of tag portion 101 has a “quick-response” (QR) code 103 displayed thereon, which will be discussed in further detail below.

FIG. 2 shows the rear side of tag portion 101, which includes an alphanumeric component 108 and a graphic component 109. Alphanumeric component 108 includes a written instruction to a person to either scan QR code 103 or navigate to a particular uniform-resource locator (URL) appearing on tag portion 101 in plain-text form (in this example, MyID2.com) and to enter a unique tag code (in this example, SABCDEF) that also appears on tag portion 101 in plain-text form. Graphic component 109, in like manner to medallion tag 107, displays a recognized medical alert-related symbol, such as a caduceus, a blue star of life (a six-pointed star), a red cross symbol, or the like, to indicate the presence of a medical condition and/or the availability of medical information for the wearer.

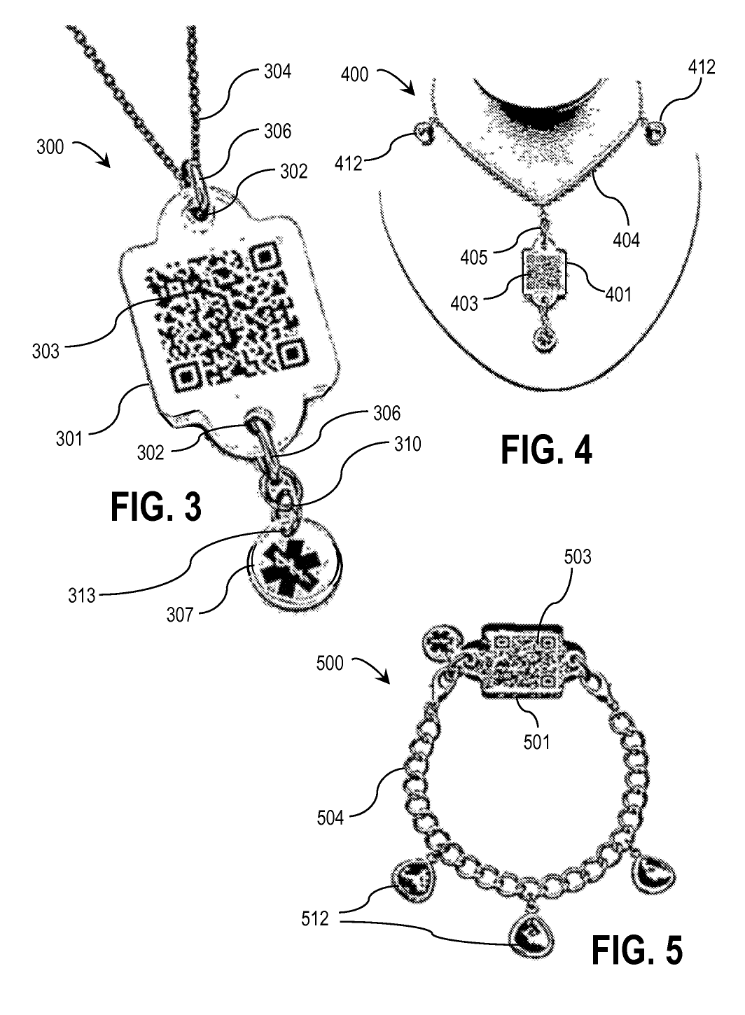

FIG. 3 shows an exemplary medical ID device 300 consistent with a second embodiment of the invention. Device 300 is similar to device 100 of FIG. 1, except that device 300 is a medical ID necklace instead of a medical ID bracelet. Device 300 includes a tag portion 301, which may be but is not necessarily identical to tag portion 101, and has a QR code 303 on one side (as seen in FIG. 3) and a plain text URL together with a unique tag code on the other side (not shown). However, instead of connecting using a lobster-claw clasp, tag portion 301 detachably fastens to a necklace portion 304 by threading necklace portion 304 through a connector link 306 coupled to a first through hole 302 formed in tag portion 301. In this embodiment, bracelet portion 304 is formed from a ball-bearing chain. A second through hole 302 formed in tag portion 301 is coupled to a medallion tag 307 by means of connector links 306, 310 coupled to through hole 313 formed in medallion tag 307. Medallion tag 307 may be but is not necessarily identical to medallion tag 107 in the embodiment of FIG. 1.

FIG. 4 shows an exemplary medical ID device 400 consistent with a third embodiment of the invention. Device 400 is similar to device 300 of FIG. 3, except that the necklace portion 404 of device 400 includes additional features to enhance visual appearance, and tag portion 401 couples to necklace portion 404 via a lobster-claw clasp 405. Device 400 includes a tag portion 401, which may be but is not necessarily identical to tag portion 301, and has a QR code 403 on one side (as seen in FIG. 4) and a plain text URL together with a unique tag code on the other side (not shown). In this embodiment, the additional features for enhancing visual appearance include one or more semi-precious or precious gem stones 412, e.g., drop-cut or marquise-cut blue Capri crystals, blue zircon crystals, fuchsia crystals, graphite crystals, cubic zirconium stones, lavender crystals, sapphires, opals, diamonds, or other gem stones, or pearls, or baubles, or the like. Although, in this embodiment, gem stones 412 are shown in bezel settings, other settings may be used in alternative embodiments.

FIG. 5 shows an exemplary medical ID device 500 consistent with a fourth embodiment of the invention. Device 500 is similar to device 100 of FIG. 1, except that the bracelet portion 504 of device 500 includes additional features to enhance visual appearance. Device 500 includes a tag portion 501, which may be but is not necessarily identical to tag portion 101, and has a QR code 503 on one side (as seen in FIG. 5) and a plain text URL together with a unique tag code on the other side (not shown). In this embodiment, the additional features for enhancing visual appearance include one or more semi-precious or precious gem stones 512, e.g., drop-cut or marquise-cut blue Capri crystals, blue zircon crystals, fuchsia crystals, graphite crystals, cubic zirconium stones, lavender crystals, sapphires, opals, diamonds, or other gem stones, or pearls, or baubles, or the like. Although, in this embodiment, gem stones 512 are shown in bezel settings, other settings may be used in alternative embodiments.

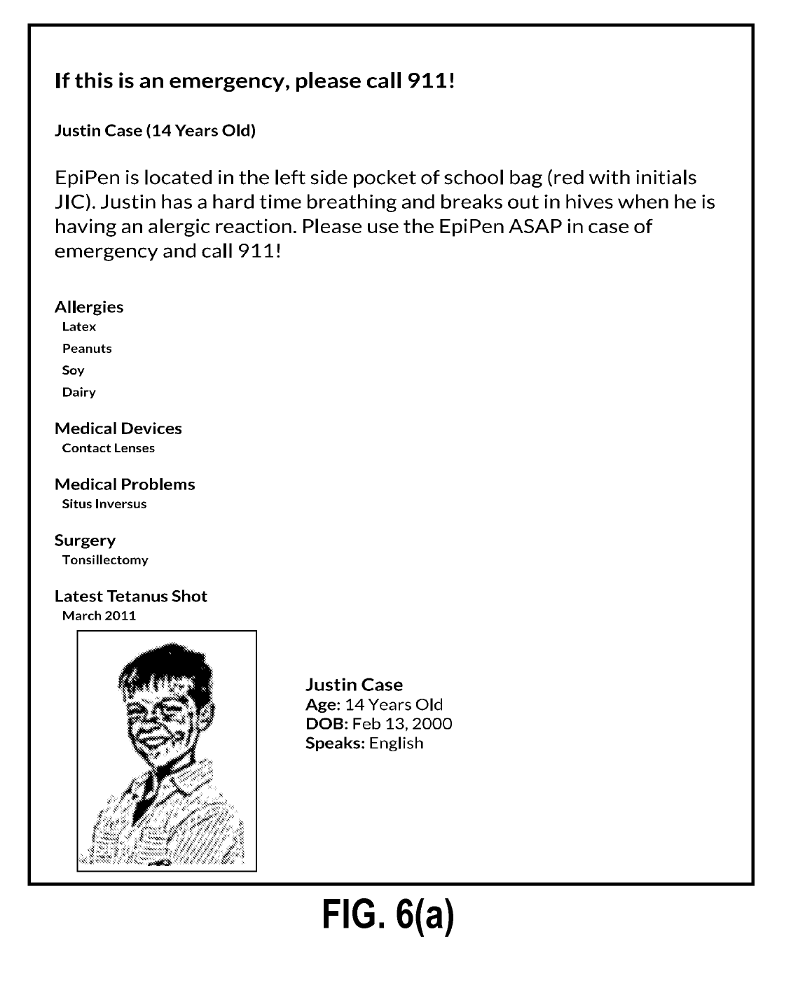

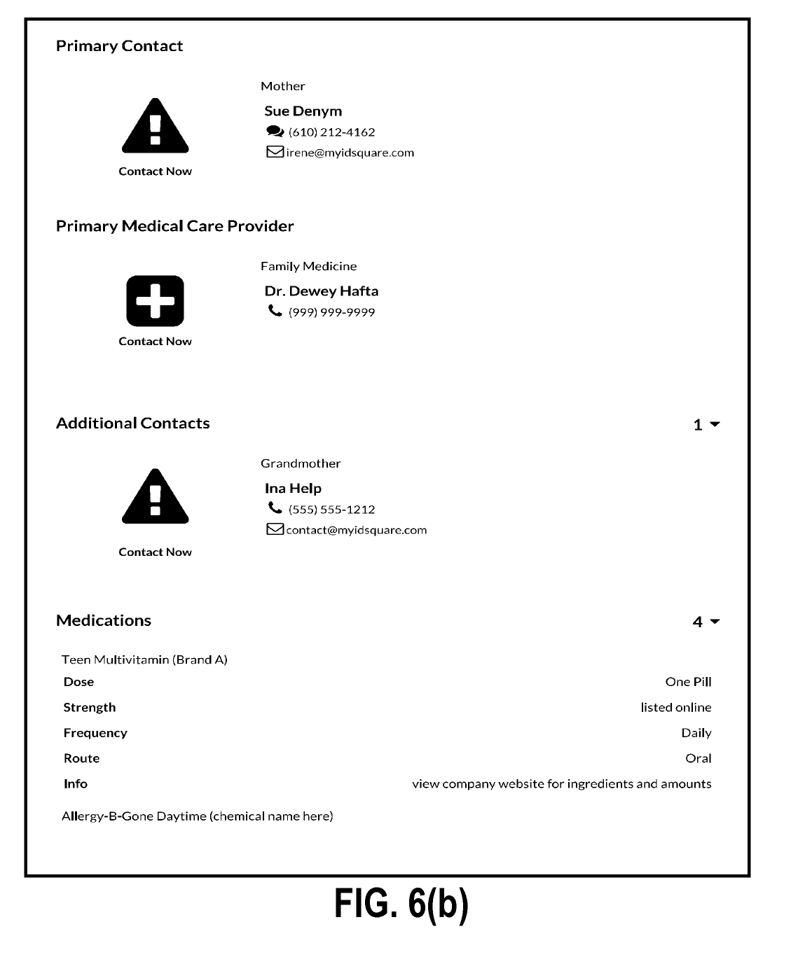

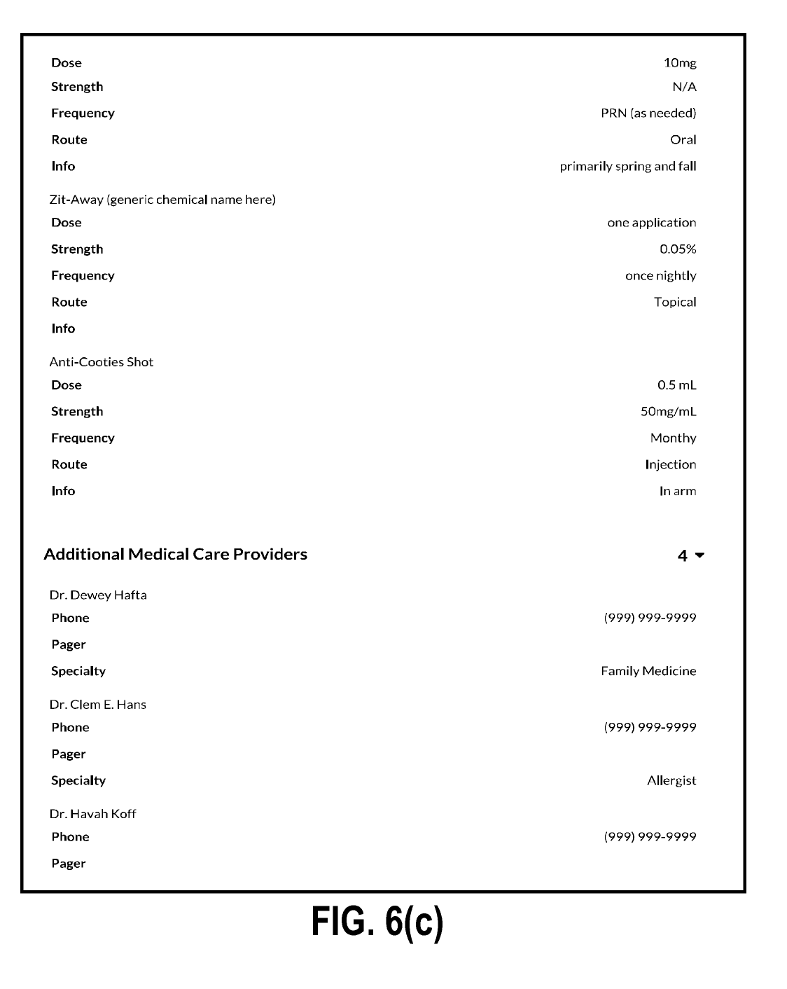

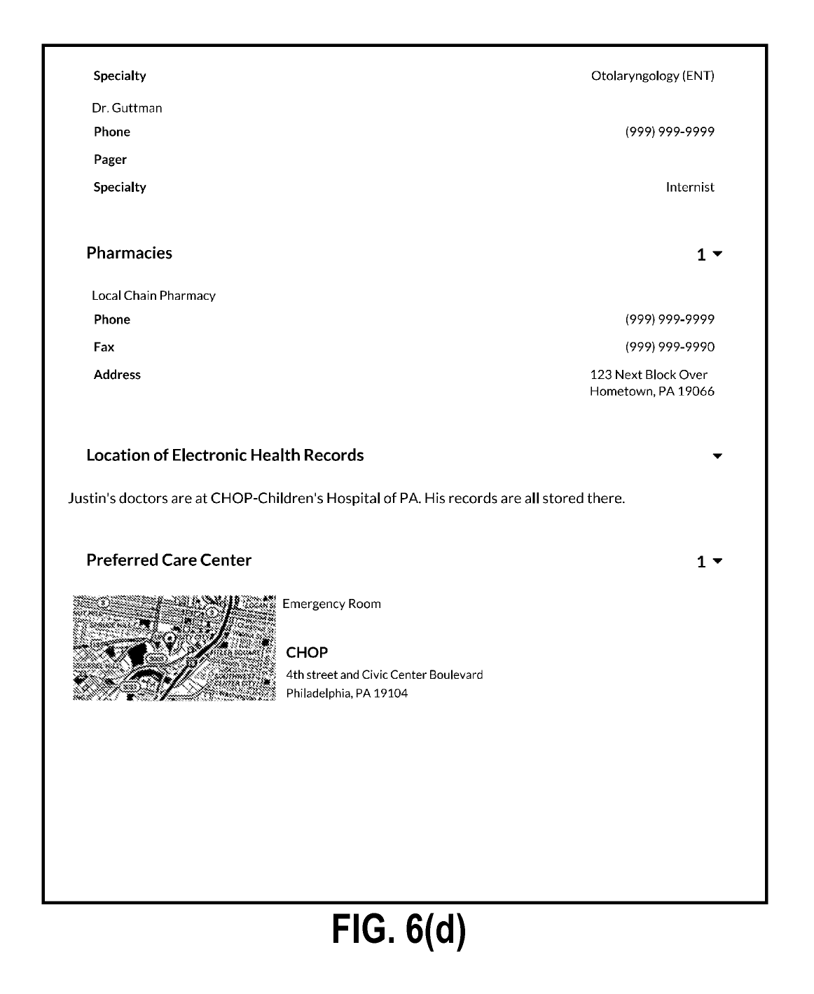

FIGS. 6(a) through 6(d) are four screen views that collectively show an exemplary emergency medical profile, in one embodiment of the invention. To enable a third party or the wearer to access the wearer's online emergency medical profile via a conventional computer, mobile phone, or other Internet-connected device, the tag portion of a medical ID consistent with embodiments of the invention desirably includes both, but may include only one of: (i) the plain text URL together with the unique tag code, and (ii) the URL in encoded (e.g., QR) form. The wearer's emergency medical profile is stored on a server in the “cloud” and can be changed whenever medical information is changed for the wearer, using a standard browser on a computer, tablet, smart phone, or the like. Additionally, information beyond traditional medical history information can be stored in the emergency medical profile, which can be valuable to emergency medical personnel and others, such as school nurses and other caregivers (e.g., “EpiPen is located in the left side pocket of school bag.”). As shown in FIG. 6(a), in this embodiment, the emergency medical profile includes the wearer's allergies, medical devices, medical problems, surgeries, immunizations, a photograph of the wearer, the wearer's age, birth date, and language spoken. FIGS. 6(b) through 6(d) show that the emergency medical profile also includes the wearer's primary and additional emergency contact information, primary and additional medical care provider information, and a list of the wearer's current medications. FIG. 6(d) also shows that the emergency medical profile includes the wearer's pharmacy information, the location of the wearer's electronic health records, and the wearer's preferred care center in case of emergency.

In some embodiments, a password or other security token may be printed on the ID adjacent to the QR code. After the QR code is scanned using a camera of a smart phone or the like, the password or token must be entered in response to a prompt before the wearer's online emergency medical profile can be viewed, thereby providing additional privacy and security for the ID wearer's information.

In the embodiments illustrated herein, the encoded form in which the URL appears on the ID is a “quick-response” (QR) code, which is a type of bar code. QR bar codes can be read by any QR code scanner or QR code reader (typically the camera of a smartphone or tablet along with decoding software) and converted into the URL that connects the scanning device to the wearer's unique online emergency medical profile. In this scenario, each ID wearer is assigned his or her own unique QR code that connects to his or her own emergency medical profile.

In one embodiment, the wearer uses a standard web interface to pre-select emergency contacts to be notified whenever his or her emergency medical profile is scanned and provides a mobile number for text messages or email address for each emergency contact. The wearer may change the pre-selected contacts at any time using the web interface. The wearer may also use the web interface to input, change, or delete his or her online emergency medical profile information, although the wearer's online emergency medical profile information may additionally or alternatively be obtained from other sources, including online medical record data from health care providers, insurance claim data, or the like. Whenever the QR code is scanned (or when the wearer's URL is accessed along with the unique tag code), in addition to the wearer's emergency medical profile being displayed, the emergency contacts of the wearer are automatically alerted, and the location of the scan will be included in the message when available.

In some embodiments, multiple medical IDs can exist, bearing the same URL and tag code and/or QR code, all linked to the same individual's emergency medical profile, and can be worn interchangeably by that same individual.

In other embodiments, each medical ID bears its own unique URL and tag code and/or QR code. In one embodiment where each medical ID bears its own unique URL and tag code and/or QR code, each medical ID is linked only to a single emergency medical profile for an individual. In another embodiment where each medical ID bears its own unique URL and tag code and/or QR code, multiple IDs having different URLS, tag codes and/or QR codes may be owned by the same individual and are all linked to that same individual's emergency medical profile.

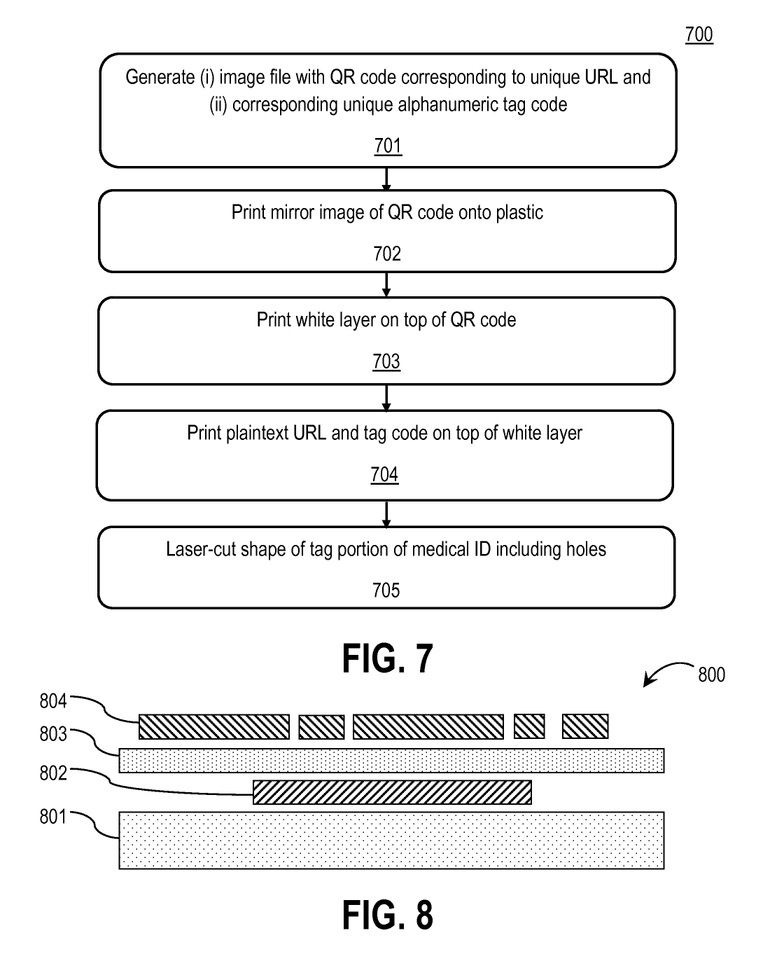

It is important that the QR code displayed on the medical ID be durable, long-lasting, protected from the elements, and reliably legible to computerized scanning equipment of various types and under unknown future conditions. During an emergency, the QR code on a wearer's ID should not be smeared, stained, worn away, or otherwise corrupted beyond the point of usability. Accordingly, as shown in the process flow diagram of FIG. 7, a fabrication method for medical IDs consistent with one embodiment of the invention involves printing the URL and tag code and/or QR code onto a tag portion in a particular way, so as to preserve the visual integrity of the printed QR code, as follows. First, at step 701, software is used to generate a file (e.g., in .pdf format) containing the image of a QR code corresponding to a unique URL encoded therein, along with a corresponding unique alphanumeric tag code. Second, at step 702, a minor-image of the QR code's image is printed using an ultraviolet (UV) inkjet printer onto a piece of clear plastic. Although other methods of printing are possible in alternative embodiments, UV printing is desirable because it cures inks using UV light, creating more vibrant color and promoting speedy drying to a hard finish relative to traditional inks that are solvent based and dry by allowing chemicals to evaporate over time. Third, at step 703, a layer of white is printed on top of the mirror-image QR code (colors other than white may be used in alternative embodiments for form a background for the QR code, so long as the color is generally uniform and creates sufficient contrast for the QR code when the QR code is imaged by an imaging device). Fourth, at step 704, the plaintext URL and tag code (and optional graphics and other information) are printed on top of the white layer. Fifth, at step 705, the shape of the tag portion, including through holes, is cut out, e.g., by laser-cutting.

FIG. 8 is an exploded cross-sectional diagram showing, schematically, the composition of layers of a part 800 of a tag portion (e.g., 101, 301, 401, or 501). As shown, a translucent substrate 801 has a minor-image 802 of a machine-readable QR code deposed on it by means of the UV inkjet printer. A white layer 803 is deposed on top of mirror-image 802 using the printer, so as to entirely cover the QR code. Human-readable and/or human-viewable information 804, including, e.g., plaintext URL, tag code, and graphics, is then deposed by the printer on top of white layer 803.

As shown in FIG. 2, tag portion 101 has a generally square or rectangular body 250 with generally semi-circular projections 260 at each end, with a through hole 102 formed in each semi-circular projection 260. Right-angle corners and edges of tag portion 101 are rounded for the wearer's comfort and to limit tag portion 101 snagging on clothing or other objects. The unique shape of the tag portion shown in FIGS. 1 through 5, which is embodied by all of tag portions 101, 301, 401, and 501, has particular utility because it facilitates the attachment of jump rings or a sports strap to the tag portion. This permits the interchangeable medical ID to be worn as a bracelet or necklace or can be attached to a shoe lace, back pack, keychain, sports strap, or the like. Accordingly, a medical ID tag consistent with certain embodiments of the invention is flexible because different attachments can be interchanged via the holes in the tag portion (e.g., using lobster-claw type clasps, or threading a chain through a ring, etc.) to permit the same tag to be worn differently by the wearer at different times—for example, first as a dog-tag style necklace, later as bracelet, then as a bracelet or necklace with gem stones, and then as an attachment to a back pack, etc. Although embodiments are shown herein in which each tag portion has two through holes, one formed in each opposing semi-circular projection, other embodiments are possible with one hole (e.g., wherein the tag portion is used as a key chain or earring), no holes at all (e.g., wherein the tag portion is retained by other means), and more than two holes (e.g., to make attachment to external items more flexible).

It should be understood that, although the foregoing description involves printing a QR code on clear plastic, in alternative embodiments, other materials can be used. For example, clear glass or another translucent material can be used. Alternatively, opaque plastic or another opaque material could alternatively be used as a printing surface for a QR code. In this scenario, the QR code is not printed as a mirror-image, but is instead printed directly onto the opaque plastic and is then cut into the shape of a tag portion, such as that shown in FIGS. 1 through 5. In some alternative embodiments, the opaque plastic is then turned over, and the tag code and plaintext URL are printed directly onto the reverse side of the opaque plastic.

Although the printing steps are described above as taking place before the cutting step, in alternative embodiments, the medical ID could be cut first from a plastic sheet, and then the printing steps could be performed. In this scenario, a cut board appropriately sized and shaped would be used during printing to hold the medical ID in place inside the flat-bed UV printer.

Although embodiments have been described herein involving QR codes with URLs encoded therein, other data can be encoded in QR codes in medical ID tags, in alternative embodiments of the invention. For example, in some embodiments, QR codes may encode text data to appear immediately without involving any web browsing. In some embodiments, a QR code encodes a URL in text data form, whereby an application decoding the QR code does not automatically navigate to the URL (as would occur with a QR code encoding a URL in normal URL form) unless a user “clicks” on the URL, copies the URL into a browser input field, or otherwise selects the URL.

Although embodiments have been described herein involving QR codes, in alternative embodiments, other methods for encoding data within medical ID tags may be used, including, e.g., two-dimensional bar codes, Datamatrix codes, Microsoft “tag” codes, MaxiCodes, Aztec codes, PDF417 codes, or MICR or OCR-scannable text. Accordingly, the term “digital identifier” should be interpreted to include any and all of the foregoing, as well as other two-dimensional codes, three-dimensional codes, scan codes, bar codes, graphic codes, and matrix codes.

As another example, an invisible capacitive ink printing method, such as a Touchcode, available from http://www.touchcode.de/, may be used to link to an online emergency medical profile for the wearer, in the manner similar to that described above for QR codes. In this scenario, one or more invisible capacitive ink codes, such as a Touchcode, may be printed directly onto a plastic medical ID, or onto one or more sections of film or labels applied to the medical ID. The invisible capacitive ink codes may be printed either normally or in mirror-image form. The touchscreen of a smartphone or tablet can be used as an input device to “read” the printed invisible capacitive ink, without need for a camera, as in the case of QR codes.

In other alternative embodiments, near-field communications (NFC) technologies may be used, whereby the plastic medical ID of the wearer contains a chip readable by an NFC reader. In this scenario, the wearer's chip might contain the actual emergency medical profile data of the wearer, or merely a link to an online emergency medical profile of the wearer, as in the case of the QR code or Touchcode medical ID embodiments described above.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, unless otherwise explicitly indicated, the term “connected” is intended to cover both direct and indirect connections between elements. For purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

I claim:

1. A medical identification device comprising:
a translucent substrate; and
a first layer deposed on the translucent substrate, the first layer including an inverse image of a digital identifier.

2. The medical identification device of claim 1, wherein the digital identifier is a quick-response (QR) code.

3. The medical identification device of claim 1, further comprising a second layer deposed on the first layer so as to entirely cover the first layer.

4. The medical identification device of claim 3, wherein the color of the second layer is generally white.

5. The medical identification device of claim 3, further comprising a third layer deposed on the second layer so as to cover at least a portion of the second layer.

6. The medical identification device of claim 5, wherein the third layer includes one or more alphanumeric indicia.

7. The medical identification device of claim 6, wherein the digital identifier corresponds to a uniform resource locator, and the one or more alphanumeric indicia include at least a portion of the uniform resource locator in plain text characters.

8. The medical identification device of claim 6, wherein the one or more alphanumeric indicia include a unique tag code associated with the medical identification device.

9. The medical identification device of claim 1, wherein the substrate has at least one hole formed therein.

10. The medical identification device of claim 1, further comprising at least one wearable portion, wherein the substrate is detachably coupled to the at least one wearable portion.

11. The medical identification device of claim 10, wherein the wearable portion is a bracelet or necklace.

12. The medical identification device of claim 10, wherein the wearable portion comprises at least one precious or semi-precious gemstone.

13. A medical identification device comprising:
a translucent substrate having an inverse image of a digital identifier deposed thereon, the digital identifier corresponding to a stored medical profile and capable of being imaged, in its non-inverse form, by an imaging device, through the translucent substrate.

14. The medical identification device of claim 13, wherein the digital identifier is a quick response (QR) code.

15. The medical identification device of claim 13, further comprising a generally white layer deposed over the digital identifier.

16. The medical identification device of claim 15, further comprising one or more alphanumeric indicia deposed on the generally white layer, the alphanumeric indicia including at least a portion of the uniform resource locator in plain text characters.

17. The medical identification device of claim 13, further comprising at least one wearable portion, wherein the substrate is detachably coupled to the at least one wearable portion.

18. The medical identification device of claim 17, wherein the wearable portion is a bracelet or necklace.

19. The medical identification device of claim 18, wherein the wearable portion comprises at least one precious or semi-precious gemstone.

20. A method for fabricating a portion of a medical identification device, the method comprising the steps of:
generating a digital identifier corresponding to a uniform resource locator;
deposing an inverse image of the digital identifier on a translucent substrate; and
deposing, on top of the digital identifier, a layer having a generally uniform color.
